(19) United States
(12) Patent Application Publication
(10) Pub. No.: US 2014/0031264 A1
(43) Pub. Date: Jan. 30, 2014

(54) METHOD OF TREATING SUBTERRANEAN FORMATIONS

(71) Applicants: Roberto Macchi, Solbiate Olona (VA) (IT); Luigi Merli, Saronno (VA) (IT); Mauro Tenconi, Gazzada (VA) (IT); Pierangelo Pirovano, Comerio (VA) (IT); Giovanni Floridi, Novara (IT); Giuseppe Li Bassi, Gavirate (VA) (IT)

(72) Inventors: Roberto Macchi, Solbiate Olona (VA) (IT); Luigi Merli, Saronno (VA) (IT); Mauro Tenconi, Gazzada (VA) (IT); Pierangelo Pirovano, Comerio (VA) (IT); Giovanni Floridi, Novara (IT); Giuseppe Li Bassi, Gavirate (VA) (IT)

(73) Assignee: LAMBERTI SpA

(21) Appl. No.: 14/110,326

(22) PCT Filed: Apr. 5, 2012
(86) PCT No.: PCT/EP2012/056247

§ 371 Date: Oct. 7, 2013

(30) Foreign Application Priority Data
Apr. 7, 2011 (IT) VA2011A000011

(51) Int. Cl. C09K 8/68

(52) U.S. Cl. CPC C09K 8/68
USPC 507/204

(57) ABSTRACT

A method of treating a portion of a subterranean formation through the use of an aqueous fracturing fluid comprising dissolved therein from 0.3 to 3.0% by weight of a viscosifying agent, wherein the viscosifying agent consists of fast dissolving and easy dispersible glyoxalated, ground guar splits containing from 0.01 to 0.05% by weight of glyoxal.

### TECHNICAL FIELD

The present disclosure relates to a method of treating a portion of a subterranean formation comprising the use of an aqueous fracturing fluid containing fast dissolving and easily dispersible glyoxalated, ground guar splits and to a process for preparing fast dissolving and easily dispersible glyoxalated, ground guar splits.

### BACKGROUND OF THE ART

Hydraulic fracturing is widely used for stimulating petroleum production and recovery from subterranean formations.

It involves the injection of a suitable fluid down a well bore to reach a formation; the fluid shall be injected under sufficient pressure to extensively crack the formation and to provide passageways for the oil and gas that is contained in the pore spaces of the formation and help them flowing to the well bore. Suitable particulate materials (proppants) are often injected in the formation to prevent closure of the fractures. Usually, fracturing fluids are gelled with water soluble polymers, especially with natural polymers or derivatized natural polymers, to most effectively widen the fractures and inhibit fluid loss.

Water soluble polymers are manly available in powder form and must be dissolved in the aqueous fluid to perform their viscosifying function. Dissolution of natural polymer particles in aqueous fluids is typically accompanied by the formation of lumps; upon contact with water, a thin, sticky layer of gel forms on the surface of the particles preventing water from hydrating the inner part of the particles and favoring the formation of lumps.

As a consequence, the whole hydration step of the polymer is undesirably prolonged, especially if the polymer shall be dissolved in large amounts of saline aqueous fluids, which often happens in the preparation of aqueous fracturing fluids.

Among the natural polymers that are used to thicken fracturing fluids, guar gum flour is widely used, because it forms strong gels in combination with crosslinkers based on titanium, zirconium and boron salts.

To provide a gelled fracturing fluid, guar gum and guar derivatives shall be previously dissolved in the aqueous component of the fluid and then gelled with a crosslinking composition.

Unfortunately, also the dissolution of guar gum and guar derivatives suffers from the disadvantages described above.

Many solutions have been put into practice to avoid lumping, including apparatus that are specifically designed to hydrate the polymers and to continuously produce viscous treatment gel close to the oilwell site, as it is known from US 2006107998.

Another way to rapidly hydrate the viscosifying polymers is to prepare a concentrated slurry of the polymer in a non-aqueous carrier fluid, usually a hydrocarbon fluid, which facilitates the polymer dispersion and slurry mixing, but may represent a concern for the environment and an additional cost.

It is also well known in the art (by way of example from U.S. Pat. No. 5,165,479) to treat natural gums in general with small amounts of glyoxal, borates and the like, to inhibit hydration and minimize the formation of lumps upon contact with water.

U.S. Pat. No. 3,808,195, by way of example, describes how to treat guar gum splits with boron salts to obtain a dispersible water soluble polygalactomannan.

Unfortunately, the reaction with borates is reversible with pH changes; therefore, the borated product shall be pre-solubilised at acidic pH in the fluid and, normally, the fluid shall be reverted to basic pH before crosslinking and injection into the well bore.

Another limit of borated guar is related to the fact that boric acid derivatives are at present classified as substances toxic for reproduction of category CMR 2.

Therefore, it would be highly desirable to provide a guar gum which is readily soluble at neutral or basic pH, is devoid of boric acid derivatives and can be used as viscosifying agent for aqueous based fracturing fluids because of its dispersibility and fast dissolving characteristics.

Although treatment with aldehydes is well known to improve dispersibility of guar, the net result of the treatment with aldehydes disclosed by the prior art is a guar that is dispersible but has a dissolution time which is unsuitable for fracturing operations.

U.S. Pat. No. 3,297,583, by way of example, describes a method for the rapid and lump-free dissolution of many macromolecular substances that involves the use of from 0.005% to 5% by weight of aldehydes.

In U.S. Pat. No. 3,297,583 guar is cited among the many macromolecular substances that can be treated and glyoxal and formaldehyde are the preferred aldehydes, but no hint is made at fracturing fluids; according to one of the examples, it takes half an hour to completely dissolve the glyoxal treated guar in water at 2 wt %.

CA 2,063,365 describes a multistep process for derivatizing guar gum, in which the alkaline derivatized guar reaction mixture is reacted with glyoxal under acid pH conditions prior to washing, and, after washing, is further reacted with a base. The resulting derivatized guar gum is said to hydrate readily under both acid and alkaline pH conditions. The amount of glyoxal used is about 0.2 to about 2% by weight based on the weight of the starting non derivatized guar.

U.S. Pat. No. 6,197,100 describes compositions of water soluble polymers, such as cellulose ethers, guar, or derivatives thereof, that have been surface-treated with surfactants to improve the dispersibility of the polymer in aqueous media. The treatment with surfactants may also be accomplished on a dry, glyoxal treated polymers (obtained from an organic solvent slurry or by spraying the polymer with an aqueous solution of glyoxal); alternatively the surfactant and glyoxal may be applied together, dissolved in an organic solvent (e.g. methanol or acetone).

The water soluble polymer compositions of U.S. Pat. No. 6,197,100 find application as thickeners and are tested in paper coating application, paint application and oil field application (drilling fluids system), but not in fracturing fluids.

A drawback of the compositions of U.S. Pat. No. 6,197,100 is that the use of surfactants may have an adverse foaming effect especially during dissolution.

Finally, US 2003/0124195, concerns a complex method for preparing a hydrocolloid powder compositions exhibiting good dispersibility in an aqueous media and a controlled hydration time obtained by treating the hydrocolloid with an aqueous solution of crosslinking agent that has been absorbed on a highly absorptive inert support powder. Fracturing fluids are not cited among the fields of use of the compositions of US 2003/0124195.

Although treatment with glyoxal is known to be useful for enhancing dispersibility of guar gum, which is essential for its effective utilization, the known glyoxalated guars hydrate slowly; the net result of glyoxal treatment is therefore a long dissolution time which in fracturing is particularly undesirable.

It has now been found how to obtain easily dispersible and fast dissolving glyoxalated, ground guar splits, that can be utilized as viscosifying agent for aqueous fracturing fluids and do not contain surfactants and are not supported by inert water insoluble powders.

### SUMMARY OF THE INVENTION

In one aspect, the disclosure relates to a method of treating a portion of a subterranean formation comprising:

a. providing an aqueous fracturing fluid comprising dissolved therein from 0.3 to 3.0% by weight of a viscosifying agent, wherein the viscosifying agent is fast dissolving and easily dispersible glyoxalated, ground guar splits containing from 0.01 to 0.05% by weight of glyoxal; b) adding a crosslinking composition and placing the treatment fluid into a portion of a subterranean formation.

In another aspect, the disclosure relates to a process for preparing fast dissolving and easily dispersible glyoxalated ground guar splits comprising the following steps: i) guar splits or ground guar splits are soaked in 0.3 to 2 parts by weight of an aqueous solution containing 0.01 to 0.05% by weight of glyoxal based upon the guar splits, to obtain soaked glyoxalated guar; ii) without washing the soaked glyoxalated guar, grinding and drying it to obtain the glyoxalated ground guar splits. In yet another aspect, the disclosure relates to a viscosifying agent for aqueous based fracturing fluids that is obtained from the above process and essentially consists of fast dissolving and easily dispersible glyoxalated, ground guar splits containing from 0.01 to 0.05% by weight of glyoxal that: i) provide in 3 minutes at least 70% of their maximum 0.48 wt % Fann viscosity in aqueous 2 wt % KCl at pH from 6.5 to 9 and 300 rpm; ii) provide 1 wt % aqueous solutions that show no lumps or fish eyes after stirring at 1,200 rpm for one minute; iii) are free from surfactants and are not supported by inert water insoluble powders.

### DETAILED DESCRIPTION OF THE INVENTION

Guar is the most commonly used polygalactomannan. Polygalactomannans are polysaccharides mainly composed of galactose and mannose units and are usually found in the endosperm of leguminous seeds such as guar, locust bean, honey locust, flame tree, and the like. The polygalactomannans may be used in either their natural form or may be substituted with one or more functional groups (e.g., carboxymethyl group).

For the purpose of the present disclosure guar is the non-derivatized polygalactomannan.

Guar splits are the endosperms of guar seeds; they are here meant to include purified splits and double and triple purified splits, that are obtainable from guar seed by mechanical separation of the endosperm from the hull and germ of the seed.

According to the process of the present disclosure, that allows the preparation of fast dissolving and easily dispersible glyoxalated ground guar splits that can be used as viscosifying agents in aqueous based fracturing fluids, guar splits can be glyoxalated as such or after being ground.

The glyoxalated, ground guar splits containing from 0.01 to 0.05% by weight of glyoxal which are contained in the aqueous fracturing fluid of the method of the present disclosure are fast dissolving and easily dispersible.

With the expression “fast dissolving” we designate products that provide in 3 minutes at least 70% of their maximum 0.48 wt % Fann viscosity in aqueous 2 wt % KCl at pH from 6.5 to 9 and 300 rpm.

With the expression “easily dispersible” we designate products whose 1% by weight aqueous solutions that show no lumps or fish eyes after stirring at 1,200 rpm for one minute after stirring at 1,200 rpm for one minute.

In the present text, when referring to the glyoxalated, ground guar splits of the invention, “providing no lumps” is used as a synonym of the expression “easily dispersible”.

According to a preferred embodiment of the disclosure, the glyoxalated, ground guar splits to be used in the method of treating subterranean formation provide their maximum 0.48 wt % Farm viscosity, which is at least 40 mPa·s, in no more than 60 minutes in aqueous 2 wt % KCl at pH from 6.5 to 9 and 300 rpm.

The glyoxalated, ground guar splits of the disclosure preferably passes for 95% of their weight through a 200 mesh sieve (200 mesh are equivalent to 0.074 mm); beside grinding, the preparation of the glyoxalated, ground guar splits may include a final sieving step, that may serve to shift the average particle size of the product in this preferred range.

The amount of glyoxal which is used in the process, from 0.01 to 0.05% by weight based on weight of guar, has proved to be one of the critical features of the present disclosure, together with the concentration of the aqueous glyoxal solution which is used to treat the ground guar splits or the guar splits.

Glyoxalated, ground guar splits containing from 0.02 to 0.04% by weight of glyoxal are most preferred; the best results in term of dispersibility and fast hydration have been obtained by dosing about 0.03% by weight of glyoxal in the process, based upon the weight of guar.

It is underlined that the specified amount of glyoxal contained in the glyoxalated, ground guar splits of the present disclosure comprises both linked and possibly unreacted glyoxal; the glyoxal content according to the present disclosure is determinable by photometrical test after derivatization with 3-methyl-2-benzothiazoline hydrazone hydrochloride. In the method of treating a portion of a subterranean formation of the disclosure, the glyoxalated, ground guar splits are obtained by a process comprising the following steps: i) guar splits or ground guar splits are soaked in 0.3 to 2 parts by weight of an aqueous solution containing 0.01 to 0.05% by weight of glyoxal based upon the guar splits, to obtain soaked glyoxalated guar; ii) without washing the soaked glyoxalated guar splits, grinding and drying them to obtain the glyoxalated ground guar splits. Step i) of the process, in which guar splits are soaked in 0.3 to 2 parts by weight of an aqueous solution containing glyoxal, is generally performed temperature from 15 to 95° C. for from 0.5 to 2 hours. In spite of the low amount of glyoxal that is used in the process in respect of guar, it has surprisingly been found that soaking the guar splits with the above amount of glyoxal aqueous solution (i.e. with a diluted glyoxal aqueous solution) gives a final product that has a remarkably improved dispersibility, as compared with the product that is obtainable by operating according to U.S. Pat. No. 3,297,583, by spraying a higher amount of glyoxal dissolved in a much more concentrated glyoxal aqueous solution.

Another advantage of the process according to the present disclosure is the fact that it does not necessarily require the use of organic solvents, such as acetone and methanol.

In the process of the disclosure the drying step may be accomplished at temperature from 70 to 200° C.

According to a preferred embodiment of the disclosure, the method of treating a portion of a subterranean formation comprises the use of glyoxalated ground guar splits that have not been ground before being soaked.

According to this preferred embodiment the process of the invention does not require the use of any organic solvent; the aqueous solution in which the guar splits are soaked does not contain organic solvents and essentially consists of water and glyoxal (glyoxal aqueous solution).

Possibly, a weak organic acid can be present in the glyoxal aqueous solution, although this has proven not to be strictly necessary.

In this embodiment, the preferred amount of glyoxal aqueous solution is from 0.5 to 1.5 parts by weight based upon the weight of the guar splits; the preferred amount of glyoxal is from 0.02 to 0.04% by weight of glyoxal based upon the guar splits, the best result being obtained by using 0.03% by weight of glyoxal based upon the guar splits.

Alternatively, the method of treating a portion of a subterranean formation comprises the use of guar splits that have been being ground before being soaked.

Grinding in this case is effected to reduce the untreated splits to such a particle size that they pass for at least 95% of their weight through a 200 mesh sieve.

According to this embodiment, in step i) the ground guar splits are preferably soaked in from 0.3 to 0.8 parts by weight of an aqueous solution which, more preferably, is an isopropanol aqueous solution containing from 50 to 80% by weight of isopropanol.

The preferred amount of glyoxal to be used in step i) is the same as in the process wherein the guar splits are treated with glyoxal before being ground, that is from 0.02 to 0.04% by weight of glyoxal, most preferably about 0.03% by weight, the amount of glyoxal being based upon the ground guar splits.

The above described process provides fast dissolving and easily dispersible glyoxalated ground guar splits that are advantageously used as viscosifying agents in aqueous based fracturing fluids.

In the method for treating a subterranean formation according to the disclosure, the crosslinking compositions utilizable in step b. are those commonly used in the field.

The use of a crosslinking agent substantially increases the viscosity of the polymer solution by forming a crosslinked polymer network in the aqueous based fluid.

While a variety of crosslinking agents can be utilized to crosslink the thickened aqueous fluid, preferred crosslinking agents include, but are not limited to, boron, zirconium and titanium-based crosslinkers. Examples of such crosslinking agents include: borate ion releasing compounds, such as boric acid, boric oxide, pyroboric acid, metaboric acid, borax, sodium tetraborate, pentaborate; ulexite, colemanite, and other slow dissolving crosslinking borate minerals; transition metal ion releasing compounds, such as titanium dioxide, zirconium oxychloride, zirconium lactate, zirconium glycolate, zirconium lactate triethanolamine, zirconium acetylacetonate, titanium citrate, titanium malate, titanium tartrate, and other titanium and zirconium chelates.

If desired, mixtures of the crosslinking agents may be used in the crosslinking composition.

Preferably crosslinking compositions also comprise a delaying agent. These delaying agents delay the rate of crosslinking reaction for a sufficient time to allow the aqueous thickened fluid to be pumped into the subterranean zone. Glyoxal also may be introduced in the fracturing fluid after dissolution of the glyoxalated ground guar splits to act as delaying agent.

Most advantageously the crosslinking agents are non-borated and the viscosifying agent is useful to provide a boron free fracturing method, that is a method for fracturing a subterranean formation without the use of fluids that comprise boron salts, which is particularly desirable for eco-toxicological reasons.

The aqueous fracturing fluid, beside the viscosifying agent, the crosslinking composition and the aqueous component, contains the normally used additives, well known by those skilled in the art, such as proppants, gel breakers, buffers.

Useful gel breakers include, but are not limited to, ammonium persulfate, sodium persulfate, sodium bromate and sodium chlorite, enzymes. Preferably, the gel breaker is a delayed gel breaker, such as encapsulated ammonium persulfate. A delayed gel breaker slowly releases the oxidizer from the polymer coating to enable a strong initial gel to carry and to deposit the proppant in the formation.

The fluid also optionally includes one or more proppants suspended in the fluid.

Useful proppants include, but are not limited to, gravel, sand, resin coated sand, ceramic beads, bauxite, glass, glass beads and mixtures thereof. The aqueous fracturing fluid also optionally includes one or more buffers. Useful buffers include, but are not limited to, potassium carbonate, sodium carbonate, potassium bicarbonate, sodium bicarbonate, potassium hydroxide, sodium hydroxide, and mixtures thereof.

The buffer may be added to the fluid prior to adding the crosslinking composition.

The aqueous fracturing fluid of the disclosure may optionally include one or more conventional additives that do not adversely affect the performance of the well treatment fluid. Such additives include, but are not limited to, clay stabilizers, gel stabilizers, surfactants, bactericides and the like.

Generally the thickened aqueous fracturing fluids of the invention have a viscosity of above about 50 mPa·s at 100 sec⁻¹, and, more preferably, above about 100 mPa·s at 100 sec⁻¹.

The aqueous component of the fracturing fluid may be selected from fresh water, salt water, seawater, natural or synthetic brine, mixtures of water and water soluble organic compounds, any other aqueous liquid that does not interact with the other components of the well treatment fluid to adversely affect its performance, and mixtures thereof.

In the method of the disclosure, the aqueous fracturing fluid is finally pumped or injected into the subterranean formation (e.g., from the surface through the well bore). Preferably, the fluid is pumped or injected at a pressure sufficient to fracture the formation (e.g., generate a plurality of fractures), and thus to enable the particulate solid (proppant) suspended in the well treatment fluid to be carried into the fractures by the fluid and deposited in them.

Although the viscosifying agents of the disclosure are particularly useful in hydraulic fracturing operations, their use is not limited thereto. The glyoxalated ground guar splits of the invention may be used in a wide variety of applications in the textile industry, in the paper, explosives and pharmaceutical industry, in the cosmetic and toiletries field, in mining and civil engineering, in the agrochemical industry, in the preparation of paints and varnishes and in the building additives industry.

The following examples are included to demonstrate preferred embodiments of the invention.

### EXAMPLES

### Example 1

8 kg of guar splits have been soaked with 10 kg of water containing 6 g of a 40 wt % of glyoxal aqueous solution.

The guar splits have been left for 1 hour under stirring at room temperature.

The glyoxalated guar splits (sample 1-A) have been flaked, ground, dried, sieved at 200 mesh and then tested against the reference material (i.e. against guar splits subjected to the same treatment but without glyoxal in the aqueous solution, sample 1-B).

### Example 2

8 kg of ground guar splits (95 wt % passing through 200 mesh) have been soaked with an aqueous solution made from 0.8 kg of water, 2.1 kg of isopropanol and the quantity of glyoxal reported in Table 1 by use of a 40 wt % of glyoxal aqueous solution.

The ground guar splits have been left for 45 minutes at 60° C. under stirring.

After this time the isopropanol has been distilled off from the reaction mixture and the so obtained glyoxalated ground guar splits (samples 2-A, 2-B and 2-C) have been ground, dried, sieved at 200 mesh and then tested against the reference material without glyoxal (i.e. against the non treated ground guar splits, sample 2-D).

### Example 3 (Comparative)

Preparation of glyoxalated guar according to U.S. Pat. No. 3,297,583 60 g of grounded guar splits (95 wt % passing through 200 mesh) were sprayed in a mixing vessel with a solution consisting of 1.48 g of a 40 wt % of glyoxal aqueous solution, 2.40 g of 80% acetic acid and 2.21 g of water. Then the moistened mixture was admixed and heated for one and a half hours at 60° C. in a drying chamber to obtain a powder that after 200 mesh sieving did not differ in appearance and grain size from the starting grounded guar splits. The sample (3-A) has been tested against the reference material without glyoxal (i.e. against the non treated ground guar splits, sample 3-B)

### Example 4 (Comparative)

60 g of ground guar splits (95 wt % passing through 200 mesh) were sprayed in a mixing vessel with a solution consisting of 0.048 g of a 40 wt % of glyoxal aqueous solution, 2.40 g of 80% acetic acid and 3.15 g of water.

Then the moistened mixture was admixed and heated for one and a half hours at 60° C. in a drying chamber to obtain a powder that after 200 mesh sieving did not differ in appearance and grain size from the starting ground guar splits. The sample (4-A) has been tested against the reference material without glyoxal (i.e. against the non treated ground guar splits, sample 3-B).

Application Tests

The application tests were conducted to determine the fast dissolving and easy dispersibility properties of the glyoxalated ground guar gum according to the invention.

The methods used in the application test are the following:

Dispersibility Test

In a 600 ml beaker add 396 g of tap water and 4 g of sample without mixing. After 1 minute stir with a magnetic bar (5 cm length) at 1200 rpm. After 1 minute stop the stirring and check visually if lumps or fish eyes (small translucent lumps) are present.

The Easy Dispersibility (as reported in Table 1) is achieved if the solution shows no lumps or fish eyes.

Fann Viscosity Test

In a Waring Blender cup add 500 ml of deionized water and 10 g of KCl.

Heat or cool the solution to 24° C.

Start the stirring at 2000 rpm and add in 5 seconds 2.40 g of sample.

Start the chronometer and run the solution for 90 seconds.

Put the solution in a FANN viscometer cup and read the viscosity at 300 rpm after 3 minutes (V_{3′}) and 5 minutes from the dissolution. Keep the solution at 24° C. and mix the solution at 600 rpm for 15 seconds before reading the viscosity at 300 rpm at 30 minutes and 60 minutes after the dissolution (V_{F}-Fann viscosity at 60′ mPa·s in Table 1). In Table 1, the Hydration rate at 3′ (%) is calculated as (V_{3′}/V_{F})*100.

The results show that the glyoxalated ground guar splits according to the disclosure show excellent hydratability and dispersibility that render them perfectly suitable as viscosifier for aqueous based fracturing fluids. On the contrary, the guars of the prior art do not possess the same characteristics.

While the compositions and methods of this invention have been described in the terms of the preferred embodiments, it will be apparent to those of skill in the art that variations may be applied to the process described herein without departing from the concept and scope of the invention. All such similar substitutes and modifications apparent to those skilled in the art are deemed to be within the scope of the invention as it is set out in the following claims.

TABLE 1

| | Glyoxal | | | |
|---|---|---|---|---|
| | content | Easy | Hydration | V_{F} |
| Sample | (% wt) | Dispersibility | at 3′ (%) | (mPa · s) |
| 1-A | 0.03 | Yes | 75 | 40.5 |
| 1-B* | 0 | No | 67 | 40.5 |
| 2-A | 0.02 | Yes | 85 | 45.5 |
| 2-B | 0.03 | Yes | 85 | 45.5 |
| 2-C | 0.04 | Yes | 85 | 45.5 |
| 2-D* | 0 | No | 72 | 42.5 |
| 3-A* | 0.98 | Yes | 66 | 38.0 |
| 3-B* | 0 | No | 76 | 42.0 |
| 4-A* | 0.03 | No | nd | nd |

1-15. (canceled)

16. A method for treating a portion of a subterranean formation comprising:
preparing a an aqueous fracturing fluid by admixing:
a solution of from about 0.3 to about 3.0% by weight of a viscosifying agent with a crosslinking composition; abd
introducing the aqueous fracturing fluid into the subterranean formation;
wherein the viscosifying agent is fast dissolving and easily dispersible glyoxalated, ground guar splits containing from about 0.01 to about 0.05% by weight of glyoxal

17. The method of claim 1 wherein the glyoxalated, ground guar splits provide in 3 minutes at least 70% of their maximum 0.48 wt % Fann viscosity in aqueous 2 wt % KCl at a pH from 6.5 to 9 and 300 rpm and provide 1 wt % aqueous solutions that show no lumps or fish eyes after stirring at 1,200 rpm for one minute.

18. The method of claim 17 wherein the glyoxalated, ground guar splits provide their maximum 0.48 wt % Fann viscosity, which is at least 40 mPa·s, in no more than 60 minutes in aqueous 2 wt % KCl at a pH from 6.5 to 9 and 300 rpm.

19. The method of claim 18 wherein the glyoxalated, ground guar splits are prepared by a process comprising:
guar splits or ground guar splits are soaked in 0.3 to 2 parts by weight of an aqueous solution containing from about 0.01 to about 0.05% by weight of glyoxal based upon the guar splits, to obtain soaked glyoxalated guar; and
without washing the soaked glyoxalated guar, grinding and drying the soaked glyoxalated guar to obtain the glyoxalated ground guar splits.

20. The method of claim 19 wherein the ground guar splits have not been ground before being soaked.

21. The method oc claim 20 wherein the guar splits are soaked in from about 0.5 to about 1.5 parts by weight of water containing from about 0.02 to about 0.04% by weight of glyoxal based upon the guar splits.

22. The method of claim 20 wherein the ground guar splits have been ground before being soaked.

23. The method of claim 22 wherein the ground guar splits are soaked in from about 0.3 to about 0.8 parts by weight of an isopropanol/water solution containing from about 50 to about 80% by weight of isopropanol and from about 0.02 to about 0.04% by weight of glyoxal, the amount of glyoxal being based upon the ground guar splits.

24. A method for preparing fast dissolvable and easy dispersible glyoxalated ground guar splits comprising:
guar splits or ground guar splits are soaked in from about 0.3 to about 2 parts by weight of an aqueous solution containing from about 0.01 to about 0.05% by weight of glyoxal based upon the guar splits, to obtain soaked glyoxalated guar; and
without washing the soaked glyoxalated guar, grinding and drying the soaked glyoxalated guar to obtain the glyoxalated ground guar splits.

25. The method of claim 24 wherein the guar splits have not been ground before being soaked.

26. The method of claim 25 wherein the guar splits are soaked in from about 0.5 to about 1.5 parts by weight of water containing from about 0.02 to about 0.04% by weight of glyoxal based upon the guar splits.

27. The method of claim 24 wherein the ground guar splits have been ground before being soaked.

28. The method of claim 27 wherein the ground guar splits are soaked in from about 0.3 to about 0.8 parts by weight of an isopropanol/water solution containing from about 50 to about 80% by weight of isopropanol and from about 0.02 to about 0.04% by weight of glyoxal, the amount of glyoxal being based upon the ground guar splits.

29. Glyoxalated, ground guar splits containing from about 0.01 to about 0.05 weight percent of glyoxal that has the physical properties:
i) providing in 3 minutes at least 70% of their maximum 0.48 wt % Fann viscosity in aqueous 2 wt % KCl at pH from 6.5 to 9 and 300 rpm;
ii) provide 1 wt % aqueous solutions at that show no lumps or fish eyes after stirring at 1,200 rpm for one minute; and
iii) are free from surfactants and are not supported by inert water insoluble powders.

30. The glyoxalated, ground guar splits of claim 29 that provide their maximum 0.48 wt % Fann viscosity, which is at least 40 mPa·s, in no more than 60 minutes in aqueous 2 wt % KCl at pH from 6.5 to 9 and 300 rpm.
